(19) United States
(12) Patent Application Publication
(10) Pub. No.: US 2015/0241650 A1
(43) Pub. Date: Aug. 27, 2015

(54) INTERNAL SHUTTER MECHANISM FOR A GANGED FIBER OPTIC ADAPTER

(71) Applicant: CommScope, Inc. of North Carolina, Hickory, NC (US)

(72) Inventor: Peter T. TRAVIS, Denton, TX (US)

(73) Assignee: CommScope, Inc. of North Carolina

(21) Appl. No.: 14/628,244

(22) Filed: Feb. 21, 2015

Related U.S. Application Data
(60) Provisional application No. 61/945,046, filed on Feb. 26, 2014.

(51) Int. Cl. G02B 6/44; G02B 6/38

(52) U.S. Cl. CPC G02B 6/444; G02B 6/3825; G02B 6/4429

(57) ABSTRACT

A module for a fiber optic patching system includes a housing having a front face presenting a first row of ports and a second row of ports. An opening is formed in the front face between the first and second rows of ports. A shutter assembly slides into, and is retained within, the opening. The shutter assembly includes a first shutter, which resides in front of a first port in the first row of ports, and which is movable between a first position substantially covering the first port and a second position pivoted into the first port. The shutter assembly also includes a second shutter, which resides in front of a second port in the second row of ports, and which is movable between a third position substantially covering the second port and a fourth position pivoted into the second port.

This application claims the benefit of U.S. Provisional Application No. 61/945,046, filed Feb. 26, 2014, which is herein incorporated by reference.

### BACKGROUND OF THE INVENTION

1. Field of the Invention

The present invention relates to fiber optic connector ports. More particularly, the present invention relates to a shutter assembly which can be mounted into a port module above and below fiber optic ports, which shutter assembly has plural shutters for covering fiber optic connector ports mounted in the port module.

2. Description of the Related Art

One type of fiber optic organization component, such as a fiber tray, shelf, rack or panel, receives a trunk cable made up of a plurality of optical fibers. These fibers are fanned out at the organization component and individually connected to backsides of a plurality of fiber optic connector ports, e.g., receptacles. Male connectors can be plugged into the receptacles to form a connection between a fiber optic cable attached to the male connector and one of the fibers of the trunk cable.

When a male connector is plugged into a given receptacle, the close fit between the connector and the receptacle helps prevent dust from entering the receptacle. When a given receptacle is not in use, it may be desirable to cover the empty receptacle in some manner to keep out dust which can later interfere with the proper functioning of the receptacle. A shutter also prevents laser light from exiting the empty receptacle, which can damage a person's eyesight.

Fiber optic components other than organization components (such passive or active devices, like amplifiers, splitters, attenuators, and multiplexers) may also include one or more receptacles for receiving male connectors and may also benefit from a shutter mechanism for reducing the amount of dust entering an empty receptacle and light exiting an empty receptacle.

Dust can be kept out of a fiber optic receptacle in various ways. One approach is the use of removable plugs shaped like the ends of the male connectors that can be inserted in the receptacles. Such plugs, while effective, may be dropped and lost when being inserted or removed and may not be readily available when needed.

Various designs of spring-loaded covers and covers having living hinges for covering unused receptacles are also known in the existing art. Such covers are typically integrally connected or securely connected to features of the receptacle, and hence such shutters cannot be retroactively added to existing receptacles since such unshuttered receptacles do not have the needed features for retention, and/or space to accommodate the add-on shutter.

Applicant's prior U.S. Pat. No. 8,348,517 entitled “SHUTTER FOR A FIBER OPTIC COMPONENT AND A FIBER OPTIC COMPONENT INCLUDING THE SHUTTER,” which is herein incorporated by reference, addressed some of these concerns. In U.S. Pat. No. 8,348,517, shutter components 22 were mounted into openings 20 which existed between a first row 16 of receptacles 14 and a second row 18 of receptacles 14. More particularly, FIG. 1 illustrates a fiber optic adapter module 10 which includes a front wall 12 having a plurality of receptacles 14 configured to receive conventional male fiber optic connectors (not illustrated). The receptacles 14 are arranged in a first row 16 and a second row 18 spaced from the first row 16 by an opening 20, and each receptacle 14 is connected to an optical fiber (not shown) located inside the fiber optic adapter module 10.

Plugging a male connector into one of the receptacles 14 establishes an optical communication pathway between an optical fiber inside the fiber optic adapter module 10 and a fiber optic cable connected to the male connector in a conventional manner. The fiber optic adapter module 10 may be used in a variety of conventional environments—in various rack systems, for example, or as part of a fan-out adapter in which multiple optic fibers from a trunk cable are separated and fanned out to a plurality of receptacles such as receptacles 14.

Also illustrated in FIG. 1 are a plurality of shutter components 22 mounted between the first row 16 and second row 18 of receptacles 14 in openings 20. One of these shutter components 22 is illustrated in FIG. 2 separate from the fiber optic adapter module 10. Each shutter component 22 includes a shutter base 24 having a top 26, a bottom 28 substantially parallel to the top 26, first and second parallel side walls 30, a rear wall 32 and a front wall 34, the rear wall 32 including a tab 36.

First and second shutters 38, which may be referred to as “upper” and “lower” shutters, based on the orientation of shutter components 22 in FIG. 2, each have a first or contacting face 40 and a second or exposed face 42 and extend from front wall 34. The contacting faces 40 and/or exposed faces 42 may include indicia 49. The first and second shutters 38 are connected to the front wall 34 by first and second integral, flexible, living hinge members 44 and a central spring hinge member 46 having an elbow portion 48, which central spring hinge member 46 comprises an over-center hinge. The central spring hinge member 46 visible in FIG. 2 is connected to the lower one of the shutters 38; the upper shutter 38 also includes a central spring hinge member 46 which is illustrated in FIG. 3 but not visible in FIG. 2. Shutter component 22 is preferably molded as a single unitary component from polypropylene or polyethylene, and the unitary nature of the shutter component simplifies manufacturing and reduces or avoids assembly steps which were required with some previous covers.

Shutter base 24 is configured to fit snugly within opening 20 in fiber optic adapter module 10, and tab 36 engages a slot (not illustrated) at an inner portion of opening 20 to secure shutter component 22 in opening 20. Other arrangements for mechanically or adhesively connecting shutter base 24 to fiber optic adapter module 10 could also be used. The dimensions of the shutter base 24 and the opening 20 are selected such that, when shutter base 24 is fully inserted in opening 20, the front wall 34 of the shutter base 24 is generally aligned with the front wall 12 of the fiber optic adapter module 10 leaving flexible hinge members 44 and shutters 38 extending outwardly from the fiber optic adapter module 10. The first and second shutters 38 are shiftable between first and second positions—a first position illustrated in FIG. 3 wherein the contacting faces 40 of the shutters 38 contact front wall 12 of fiber optic adapter module 10 leaving exposed faces 42 visible to a user and a second position illustrated in FIG. 1 wherein exposed faces 42 are generally parallel and facing one another.

### SUMMARY OF THE INVENTION

The shutter assembly of FIGS. 1-3 above has been well accepted and shown improved characteristics over other conventional shutter designs. However, one drawback is that a closed shutter must first be manually opened to a point that the bi-stable hinge reaches a position tending to hold the shutter open before a fiber optic connector plug can be inserted into the port, e.g., receptacle. Also, once a connector plug is removed from a port, the shutter must be manually closed to a point that the bi-stable hinge reaches a position tending to hold the shutter closed in order for the port to be protected by the shutter.

The Applicant has appreciated that it would be desirable to provide a shutter closure for a fiber optic receptacle in a fiber optic component that is relatively inexpensive to manufacture, fits into the same space 20 between the rows 16 and 18 of receptacles 14, and that opens and closes automatically with the insertion and removal of the plug, respectively.

These and other aspects of the present invention are met by a shutter assembly which can fit into the same opening between the first row and the second row of ports. The shutter assembly includes shutters, which reside inside of the ports and which are spring biased to a position closing the ports. The shutter assembly opens inwardly into the port, rather than outwardly from the port (as shown in U.S. Pat. No. 8,348,517). By such an arrangement, the user need only insert the connector plug into the port to open the shutter and remove the connector plug from the port to close the shutter. The steps of manually opening and manually closing the shutters are eliminated, as compared to U.S. Pat. No. 8,348,517.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a module with shutter assemblies in open states, in accordance with the prior art;

FIG. 2 is a perspective view of a shutter assembly removed from the module of FIG. 1;

FIG. 3 is a perspective view of the module of FIG. 1 with shutter assemblies in closed states;

FIG. 4 is a perspective view of a module with shutter assemblies in closed states, in accordance with the present invention;

FIG. 5 is a perspective view of a shutter assembly removed from the module of FIG. 4 with first and second shutter panels in closed states;

FIG. 6 is a perspective view of the shutter assembly of FIG. 5 with the first and second shutter panels in open states;

FIG. 7 is a front view of the shutter assembly of FIG. 5;

FIG. 8 is a perspective view of the shutter assembly of FIG. 5 with the first shutter panel in an open state and the second shutter panel in a closed state to illustrate the independent operation ability;

FIG. 9 is a perspective view of a spring of the shutter assembly of FIG. 5;

FIG. 10 is a perspective view like FIG. 5, but with the first and second shutter panels removed to illustrate the installation of the spring;

FIG. 11 is a partial cutaway view showing a connector entering into a first port and beginning to contact the first shutter panel to move it from the closed state to the open state;

FIG. 12 is a partial cutaway view showing the connector mated into the first port and the first shutter panel in the open state;

FIG. 13 is a partial cutaway view showing the shutter assembly's connection to the module and a first embodiment of a shutter stop feature;

FIG. 14 is a partial cutaway view similar to FIG. 13, but illustrating an alternative shutter stop feature; and

FIG. 15 is a perspective view of a module similar to FIG. 4, but showing connectors mated into ports in a first row, and shutter panels in the first row in the open state and shutter panels in a second row in the closed state.

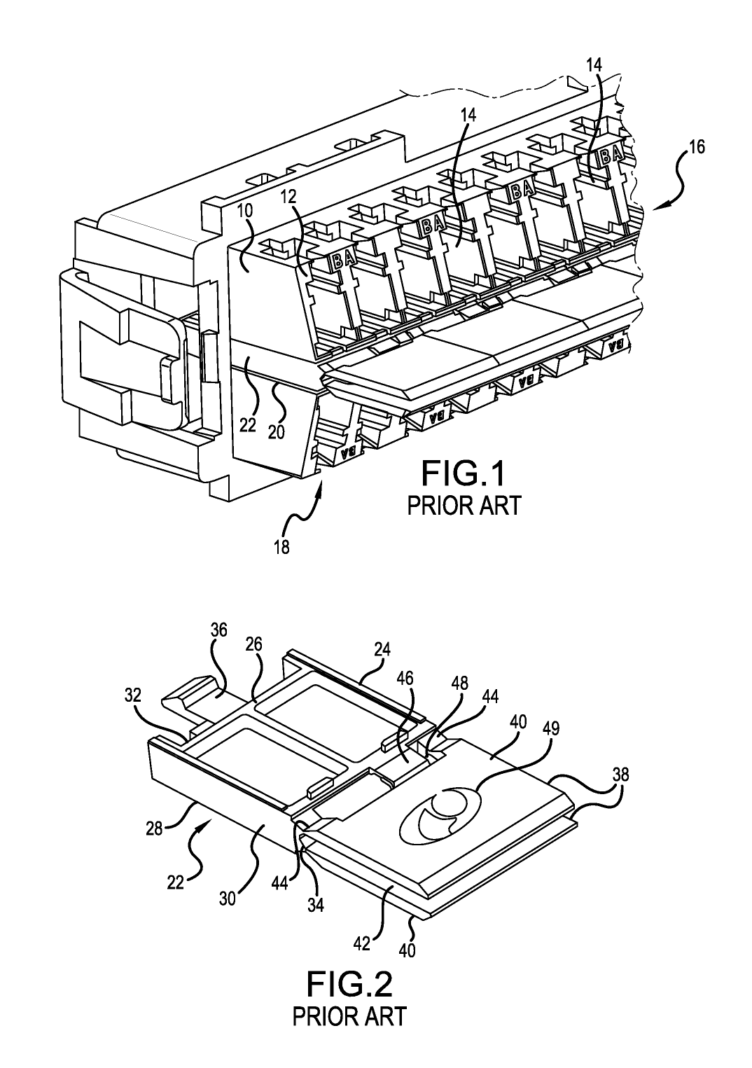

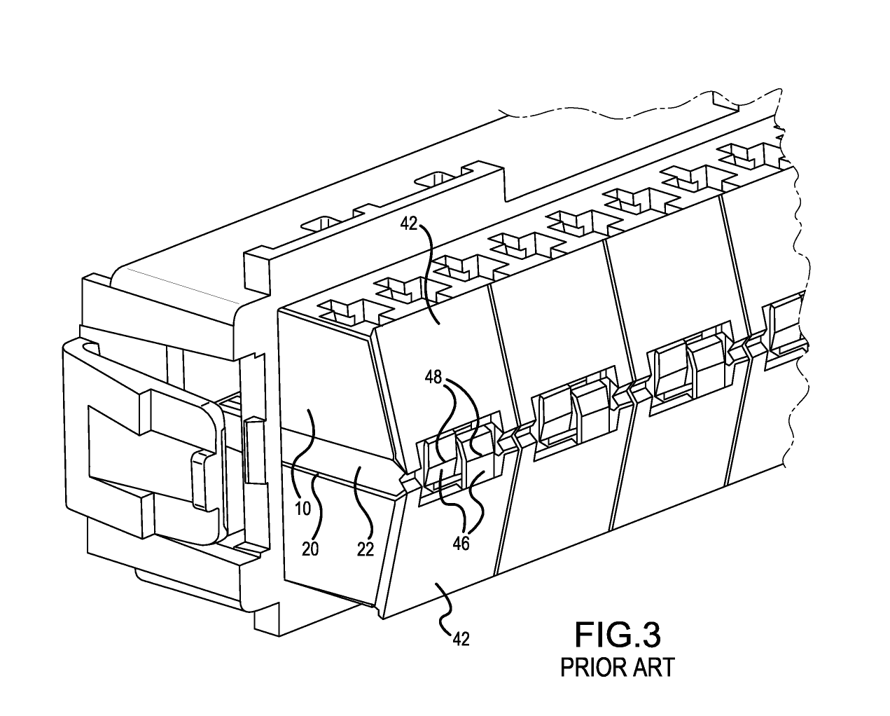

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

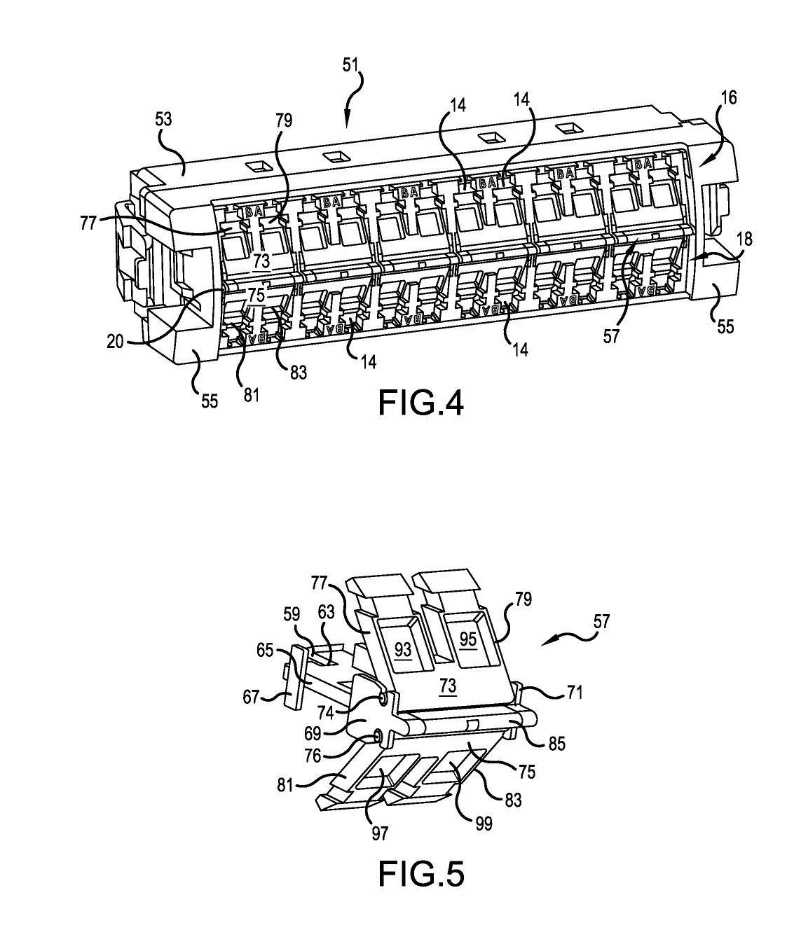

As shown in FIG. 4, a module 51 for a fiber optic patching system includes a housing 53 having a front face 55 presenting a first row 16 of ports 14 and a second row 18 of ports 14. In one embodiment, the first and second rows 16 and 18 of ports 14 each include multiple sets of duplex ports. A plurality of openings 20 are formed in the front face 55 of the housing 53 between the first row 16 of ports 14 and the second row 18 of ports 14.

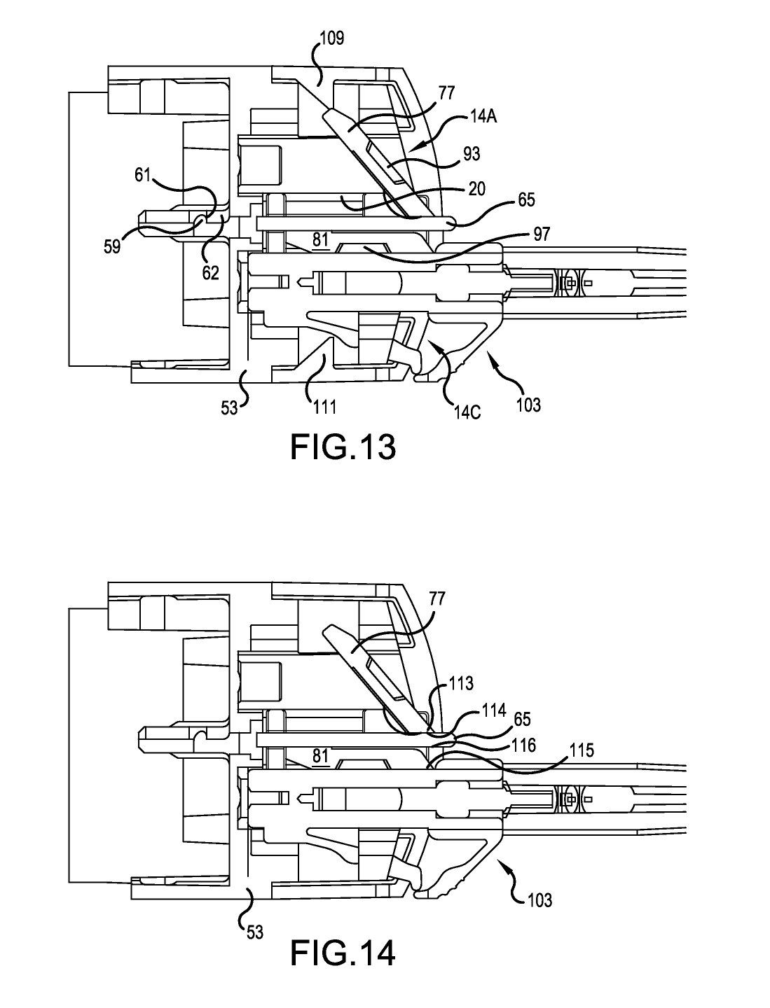

A shutter assembly 57, as shown in various view of FIGS. 5-8, slides into each opening 20 and is retained within the opening 20 by a first feature, such as a resilient latch 59 (See FIG. 5), which engages with a complimentary, second feature, such as an edge 61, formed on a wall 62 of the housing 53 within the opening 20 (See FIG. 13). The latch 59 extends from a rear portion or surface 63 of a frame 65 of the shutter assembly 57. The frame 65 may also include support features 67 to provide rigidity and strength to the frame 65, and to also cooperate with the internal features of the ports 14 to provide alignment of the shutter assembly 57 to the ports 14.

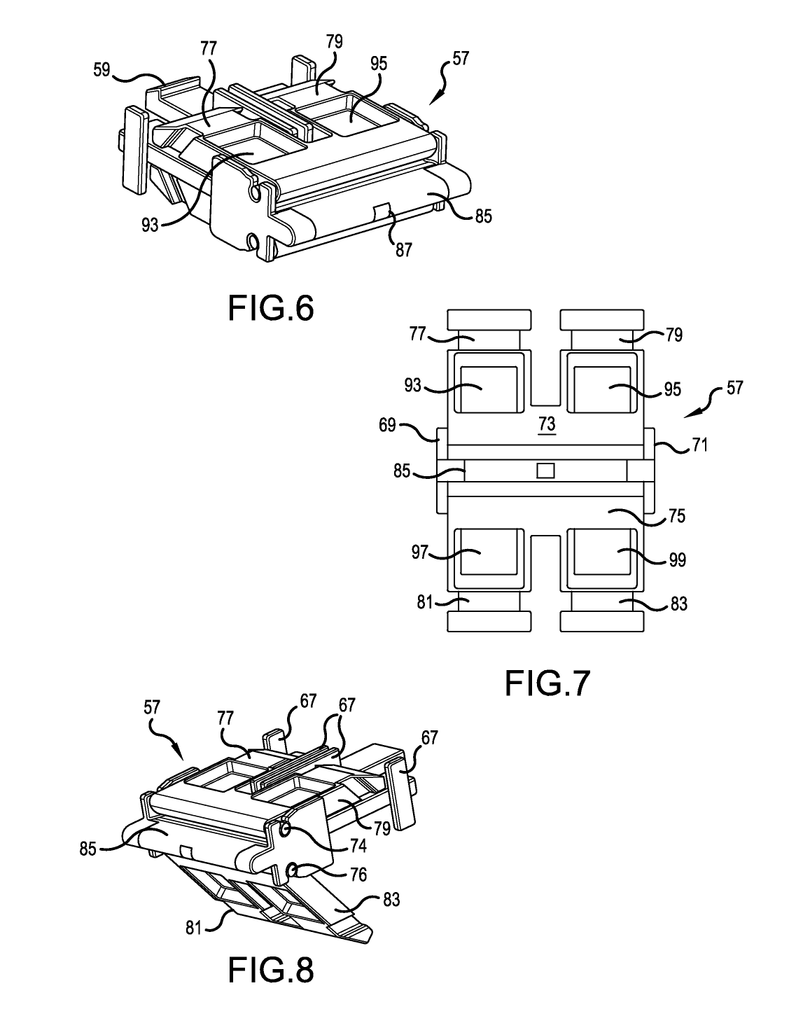

The frame 65 also includes first and second hinge plates 69 and 71. A first panel 73 is pivotably mounted to the frame 65 on a first side of the frame 65. A second panel 75 is pivotably mounted to the frame 65 on an opposite, second side of the frame 65. The first panel 73 forms a first shutter 77 and a second shutter 79 for interacting with first and second adjacent ports 14 in the first row 16. The first panel 73 is pivotable, along a pivot axis 74, between a first position (FIGS. 4-5, 7, 11, 13 and 14) wherein the first and second shutters 77 and 79 are distanced from the frame 65, substantially closing the ports 14, and a second position (FIGS. 6, 8, 12 and 15) wherein the first and second shutters 77 and 79 reside adjacent to the frame 65, leaving the ports 14 open.

The second panel 75 forms a third shutter 81 and a fourth shutter 83 for interacting with third and fourth adjacent ports 14 in the second row 18. The second panel 75 is pivotable, along a pivot axis 76, between a third position (FIGS. 4, 5, 7, 8, 12 and 15) wherein the third and fourth shutters 81 and 83 are distanced from the frame 65, substantially closing the ports 14, and a fourth position (FIGS. 6, 13 and 14) wherein the third and fourth shutters 81 and 83 reside adjacent to the frame 65, leaving the ports 14 open.

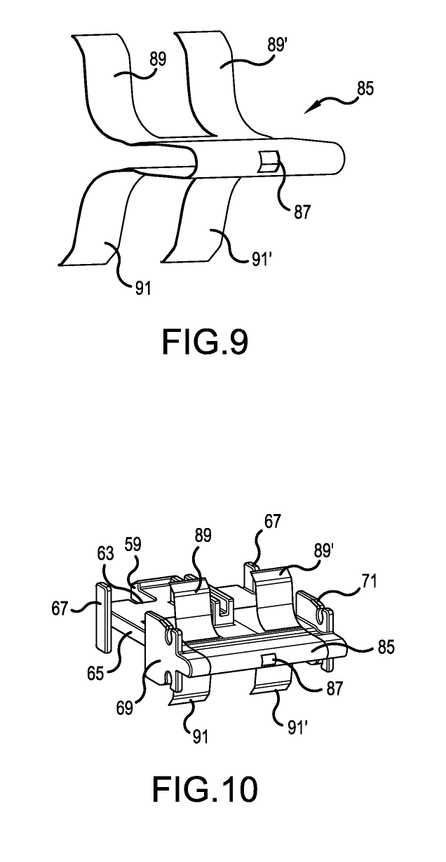

As best seen in FIG. 9, the shutter assembly 57 also includes at least one spring, such as a leaf spring 85, biasing the first panel 73 toward the first position and biasing the second panel 75 toward the third position. The leaf spring 85 includes a hole 87, which allows the leaf spring 85 to be attached to the frame 65 by tacking, welding, fasteners, or other such structures or methods. The structural arrangement between leaf spring 85 and the frame 65 is best seen in FIG. 10, wherein the first and second shutter panels 73 and 75 have been removed. The leaf spring 85 has first and second resilient portions 89/89′ and 91/91′ bearing against the first and second panels 73 and 75, respectively. Although a leaf spring has been illustrated, other types of springs may also be used, such as a torsion or coil spring.

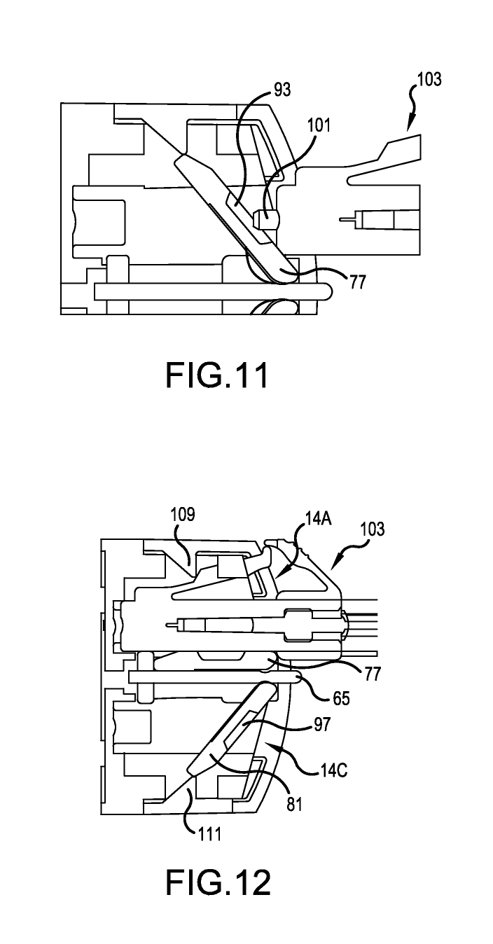

The first and second shutters 77 and 79 include first and second recessed regions 93 and 95, on respective surfaces of the first and second shutters 77 and 79, which face away from the frame 65. Likewise, the third and fourth shutters 81 and 83 include third and fourth recessed regions 97 and 99, on respective surfaces of the third and fourth shutters 81 and 83, which face away from the frame 65. The first and second recessed regions 93 and 95 accommodate ferrules 101 of connectors 103 being pressed against the first and second shutters 77 and 79, so that the ferrules 101 do not make physical contact with first and second shutters 77 and 79 as other portions of the connectors 103 move the first panel 73 from its first position to its second position (See FIG. 11). Likewise, the third and fourth recessed regions 97 and 99 accommodate ferrules 101 of connectors 103 being pressed against the third and fourth shutters 81 and 83, so that the ferrules 101 do not make physical contact with third and fourth shutters 81 and 83 as other portions of the connectors 103 move the second panel 75 from its third position to its fourth position.

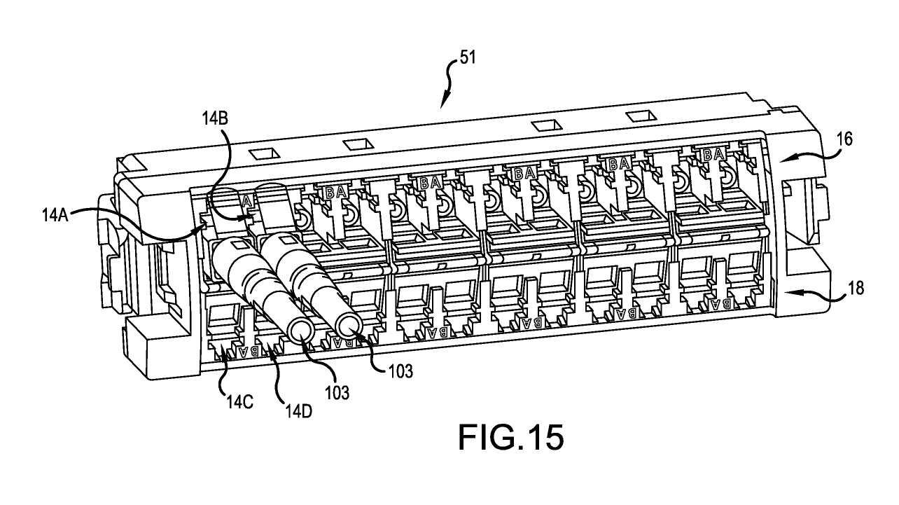

As shown in FIG. 15, once the shutter assembly 57 is attached into the opening 20 in the front face 55 of the housing 53 (as shown in FIG. 4), the first shutter 77 resides in front of a first port 14A in the first row 16 of ports 14. The first shutter 77 is movable between a first position substantially covering the first port 14A and a second position wherein the first shutter 77 has pivoted into the first port 14A to a position closer to a side within the first port 14A adjacent the opening 20 and the frame 65, which allows connector 103 access to the first port 14A. When the first shutter 77 is in the second position, the first shutter 77 forms the floor of the port 14A. The second shutter 79 interacts with a second and adjacent port 14B in the first row 16 of ports 14 and moves in unison with the first shutter 77 because the first and second shutters 77 and 79 are formed as extensions of the first panel 73.

The third shutter 81 resides in front of a third port 14C in the second row 18 of ports 14. The third shutter 81 is movable between a third position substantially covering the third port 14C and a fourth position wherein the third shutter 81 has pivoted into the third port 14C to a position closer to a side within the third port 14C adjacent the opening 20 and the frame 65, which allows connector access to the third port 14C. When the third shutter 81 is in the fourth position, the third shutter 81 forms the roof of the third port 14C. The fourth shutter 83 interacts with a fourth and adjacent port 14D in the second row 18 of ports 14 and moves in unison with the third shutter 81 because the third and fourth shutters 81 and 83 are formed as extensions of the second panel 75.

FIG. 12 illustrates a connector 103 inserted into the first port 14A of the first row 16 of ports 14, and no connector located in the third port 14C in the second row 18 of ports 14. It can be noted that first port 14A includes a first stop 109 and third port 14C includes a third stop 111. The first stop 109 acts to stop the first shutter 77 in the first position when no connector 103 is located in the first port 14A. The third stop 111 acts to stop the third shutter 81 in the third position when no connector 103 is in the third port 14C.

FIG. 13 illustrates a connector 103 inserted into the third port 14C of the second row 18 of ports 14, and no connector located in the first port 14A in the first row 16 of ports 14. In FIG. 13, the first shutter 77 is in the first position and the third shutter 81 is in the fourth position. FIG. 13 also illustrates the details of the latch 59 of the frame 65 in engagement with the edge 61 of the wall 62 of the housing 53. Other arrangements for mechanically or adhesively connecting the frames 65 into the openings 20 in the housing 53 could also be used.

FIG. 14 is similar to FIG. 13, but illustrates an alternative stop arrangement. In FIG. 14, the first stop 109 and the third stop 111 have been removed. The first shutter 77 stops at the first position when a first angular extension portion 113 of the first shutter 77 abuts a first surface 114 on a first side of the frame 65. Likewise, the second shutter 81 stops at the third position when a second angular extension portion 115 of the second shutter 81 abuts a second surface 116 on an opposite, second side of the frame 65. Of course, other structures for stopping the rotation of the first shutter 77 in the first position and the third shutter 81 in the third position may be employed. The other ports 14 of the module 51 may be formed in a like manner.

FIG. 15 shows connectors 103 populated into ports 14A and 14B. In FIG. 15, the ports 14 in the first row 16 are illustrated as being “open,” i.e., with the shutters 77 and 79 depressed. Of course, the shutters 77 and 79 would not normally be depressed unless a connector 103 had been mated into the ports 14. However, the shutters 77 and 79 are depicted as “open” in FIG. 15 solely for the purpose of illustrating the view inside the ports 14 when the shutters 77 and 79 are open and no connector 103 is present. The ports 14 in the second row 18 have the shutters 81 and 83 in their “closed” positions, which blocks dust from entering the ports 14 and which blocks light from escaping from the ports 14. With no connectors 103 in ports 14, the second row 18 illustrates the naturally closed state of the shutters 81 and 83.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

I claim:

1. A module for a fiber optic patching system comprising:
a housing having a front face presenting a first row of ports and a second row of ports;
an opening formed in said front face of said housing between said first row of ports and said second row of ports; and
a shutter assembly which slides into said opening and is retained within said opening, said shutter assembly including:
a first shutter which resides in front of a first port in said first row of ports, said first shutter being movable between a first position substantially covering said first port and a second position wherein said first shutter has pivoted into said first port to a position closer to a side within said first port adjacent said opening; and
a second shutter which resides in front of a second port in said second row of ports, said second shutter being movable between a third position substantially covering said second port and a fourth position wherein said second shutter has pivoted into said second port to a position closer to a side within said second port adjacent said opening.

2. The module according to claim 1, wherein said first row of ports includes multiple sets of duplex ports, and wherein said second row of ports includes multiple sets of duplex ports.

3. The module according to claim 1, wherein a rear portion of said shutter assembly includes a first feature which engages a complimentary, second feature formed as part of said housing within said opening to retain said shutter assembly within said opening.

4. The module according to claim 3, wherein said first feature is a resilient latch, and wherein said second feature is an edge formed on a wall of said housing, which retains said latch of said shutter assembly.

5. The module according to claim 1, wherein said shutter assembly further includes at least one spring biasing said first shutter toward said first position and biasing said second shutter toward said third position.

6. The module according to claim 5, wherein said shutter assembly further includes a frame, and wherein said at least one spring is a single leaf spring attached to said frame and having first and second resilient portions bearing against said first and second shutters.

7. The module according to claim 1, wherein said first shutter includes a recessed region, and wherein said recessed region accommodates a ferrule of a connector being inserted into said first port so that the ferrule does not make physical contact with said first shutter as other portions of the connector move said first shutter from said first position to said second position.

8. A module for a fiber optic patching system comprising:
a housing having a front face presenting a first row of ports and a second row of ports; and
a shutter assembly residing between said first row of ports and said second row of ports, said shutter assembly including:
a frame;
a first panel pivotably mounted to said frame, said first panel forming a first shutter and a second shutter, said first panel being pivotable between a first position wherein said first and second shutters substantially cover first and second ports in said first row of ports and a second position wherein said first and second shutters have pivoted into said first and second ports to allow access to said first and second ports; and
a second panel pivotably mounted to said frame, said second panel forming a third shutter and a fourth shutter, said second panel being pivotable between a third position wherein said third and fourth shutters substantially cover third and fourth ports in said second row of ports, and a fourth position wherein said third and fourth shutters have pivoted into said third and fourth ports to allow access to said third and fourth ports.

9. The module according to claim 8, wherein said first row of ports includes multiple sets of duplex ports, and wherein said second row of ports includes multiple sets of duplex ports.

10. The module according to claim 8, further comprising:
an opening formed in said front face of said housing between said first row of ports and said second row of ports, and wherein a rear portion of said frame of said shutter assembly includes a first feature which engages a complimentary, second feature formed as part of said housing within said opening to retain said shutter assembly within said opening.

11. The module according to claim 10, wherein said first feature is a resilient latch, and wherein said second feature is an edge formed on a wall of said housing, which retains said latch of said shutter assembly.

12. The module according to claim 8, wherein said shutter assembly further includes at least one spring biasing said first panel toward said first position and biasing said second panel toward said third position.

13. The module according to claim 12, wherein said at least one spring is a single leaf spring attached to said frame and having first and second resilient portions bearing against said first and second panels.

14. The module according to claim 8, wherein said first and second shutters include first and second recessed regions, and wherein said first and second recessed regions accommodate ferrules of connectors being inserted into said first and second ports so that the ferrules do not make physical contact with said first and second shutters as other portions of the connectors move said first panel from said first position to said second position.

15. A shutter assembly comprising:
a frame;
a first panel pivotably mounted to said frame, said first panel forming a first shutter and a second shutter, said first panel being pivotable between a first position wherein said first and second shutters are distanced from said frame and a second position wherein said first and second shutters reside adjacent to said frame; and
a second panel pivotably mounted to said frame, said second panel forming a third shutter and a fourth shutter, said second panel being pivotable between a third position wherein said third and fourth shutters are distanced from said frame and a fourth position wherein said third and fourth shutters reside adjacent to said frame.

16. The shutter assembly according to claim 15, wherein said first panel is mounted on a first side of said frame, and said second panel is mounted on an opposite, second side of said frame.

17. The shutter assembly according to claim 15, further comprising:
a resilient latch formed a rear surface of said frame.

18. The shutter assembly according to claim 15, further comprising:
at least one spring biasing said first panel toward said first position and biasing said second panel toward said third position.

19. The module according to claim 18, wherein said at least one spring is a single leaf spring attached to said frame and having first and second resilient portions bearing against said first and second panels.

20. The module according to claim 15, wherein said first and second shutters include first and second recessed regions facing away from said frame, and wherein said first and second recessed regions accommodate ferrules of connectors being pressed against said first and second shutters so that the ferrules do not make physical contact with said first and second shutters as other portions of the connectors move said first panel from said first position to said second position.
